(19) United States
(12) Patent Application Publication
(10) Pub. No.: US 2019/0132551 A1
(43) Pub. Date: May 2, 2019

(54) CONFERENCING APPARATUS AND METHOD FOR RIGHT MANAGEMENT THEREOF

(71) Applicant: SAMSUNG SDS CO., LTD., Seoul (KR)

(72) Inventor: Hee-Tae YOON, Seoul (KR)

(73) Assignee: SAMSUNG SDS CO., LTD., Seoul (KR)

(21) Appl. No.: 16/173,247

(22) Filed: Oct. 29, 2018

(30) Foreign Application Priority Data
Oct. 30, 2017 (KR) 10-2017-0142717

(51) Int. Cl. H04N 7/15; G06F 17/30; G06F 21/10

(52) U.S. Cl. CPC H04N 7/152; G06F 21/10; G06F 17/30171

(57) ABSTRACT

A multi-party conferencing apparatus and a right management method thereof are provided. The multi-party conferencing apparatus according to one embodiment of the present disclosure includes: a receiver configured to receive a request for sharing content from a terminal connected to a multi-party conference; and an authority controller configured to accept or reject the request for sharing content according to whether a host terminal has been designated to the multi-party conference and whether the terminal is a presenter terminal.

### CROSS-REFERENCE TO RELATED APPLICATION(S)

This application claims the benefit under 35 USC § 119(a) of Korean Patent Application No. 10-2017-0142717, filed on Oct. 30, 2017, in the Korean Intellectual Property Office, the entire disclosure of which is incorporated herein by reference for all purposes.

### BACKGROUND

### 1. Field

The following description relates to multi-party conferencing technology.

### 2. Description of Related Art

A multi-party conferencing system is a remote communication system in which two or more users access a virtual conference room and simultaneously perform a conference using voice and video. By using the multi-party conferencing, people at multiple locations can conveniently collaborate with each other.

In a multi-party conference, a means for enabling conference participants to share content, such as presentation materials, web pages, images, or video, with each other may be provided. To this end, a server for providing the multi-party conference needs an effective method for determining a presenter authorized to share content, from among the participants of the multi-party conference.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a technical means for accepting or rejecting a request for sharing content from a participant of a multi-party conference by determining whether the participant is authorized to share content.

In one general aspect, there is provided a multi-party conferencing apparatus including: a receiver configured to receive a request for sharing content from a terminal connected to a multi-party conference; and an authority controller configured to accept or reject the request for sharing content according to whether a host terminal has been designated to the multi-party conference and whether the terminal is a presenter terminal.

The authority controller may accept the request for sharing content when the host terminal has been designated and the terminal is designated as the presenter terminal by the host terminal.

The authority controller may reject the request for sharing content when the terminal is not designated as the presenter terminal by the host terminal.

The authority controller may register the terminal as the presenter terminal and accept the request for sharing content when the host terminal has not been designated and a terminal previously registered as the presenter terminal does not exist at the time of receiving the request for sharing content.

The authority controller may reject the request for sharing content when another terminal previously registered as the presenter terminal exists at the time of receiving the request for sharing content.

The authority controller may accept the request for sharing content when the terminal is the terminal previously registered as the presenter terminal.

In another general aspect, there is provided a right management method which is performed by a multi-party conference server including one or more processors and a memory in which one or more programs to be executed by the one or more processors are stored, the right management method including: receiving a request for sharing content from a terminal connected to a multi-party conference; and accepting or rejecting the request for sharing content according to whether a host terminal has been designated to the multi-party conference and whether the terminal is a presenter terminal.

The accepting or rejecting of the request may include accepting the request for sharing content when the host terminal has been designated and the terminal is designated as the presenter terminal by the host terminal.

The accepting or rejecting of the request may include rejecting the request for sharing content when the terminal is not designated as the presenter terminal by the host terminal.

The accepting or rejecting of the request may include, when the host terminal has not been designated and a terminal previously registered as the presenter terminal does not exist at the time of receiving the request for sharing content, registering the terminal as the presenter terminal and accepting the request for sharing content.

The accepting or rejecting of the request may include rejecting the request for sharing content when another terminal previously registered as the presenter terminal exists at the time of receiving the request for sharing content.

The accepting or rejecting of the request may include accepting the request for sharing content when the terminal is the terminal previously registered as the presenter terminal.

Other features and aspects will be apparent from the following detailed description, the drawings, and the claims.

### BRIEF DESCRIPTION OF THE DRAWINGS

FIG. 1 is a block diagram for describing a multi-party conferencing system according to one embodiment of the present disclosure.

FIG. 2 is a block diagram for describing a multi-party conference server according to one embodiment of the present disclosure.

FIG. 3 is a flowchart for describing a right management method according to one embodiment of the present disclosure.

FIG. 4 is a block diagram for describing an example of a computing environment including a computing device suitable to be used in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

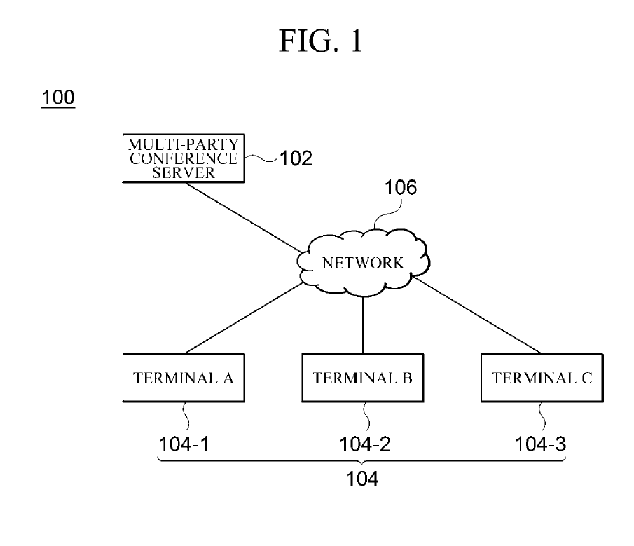

FIG. 1 is a block diagram for describing a multi-party conferencing system 100 according to one embodiment of the present disclosure. As shown in FIG. 1, the multi-party conferencing system 100 according to one embodiment of the present disclosure includes a multi-party conference server 102 and a plurality of conference participant terminals 104.

The multi-party conference server 102 is a server for providing a multi-party conference service between the plurality of conference participant terminals 104. In one embodiment, the multi-party conference server 102 may relay one or more of text, audio, and video data between two or more conference participant terminals 104, thereby enabling the plurality of conference participant terminals 104 to conduct text messaging, a voice conference, or a video conference in a virtual conference room.

Each of the conference participant terminals 104 is a terminal used by a conference participant who connects to the multi-party conference server 102 and participates in a multi-party conference. In the disclosed embodiments, the conference participant terminals 104 may include any types of communication devices which can be provided with a multi-party conference service, such as desktop computers, notebook computers, tablet computer, smartphones, wearable devices, and the like. In the illustrated embodiment, three devices including terminal A 104-1, terminal B 104-2, and terminal C 104-3 are illustrated as connecting to the multi-party conference server 102 to perform the multi-party conference, but it should be noted that the embodiments of the present disclosure are not limited to a specific number of terminals.

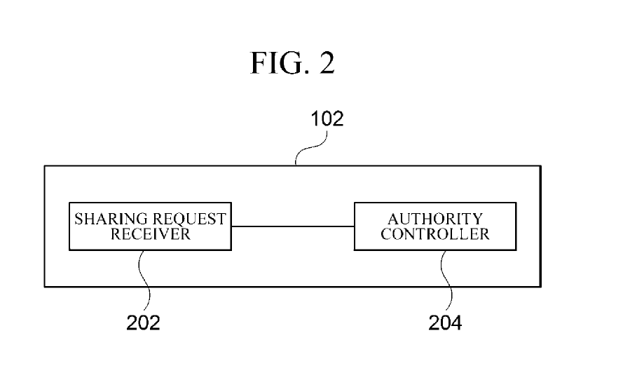

FIG. 2 is a block diagram for describing a multi-party conference server 102 according to one embodiment of the present disclosure. As shown in FIG. 2, the multi-party conference server 102 according to one embodiment of the present disclosure includes a sharing request receiver 202 and an authority controller 204.

The sharing request receiver 202 receives a request for sharing content from one of a plurality conference participant terminals 104 which connect to the multi-party conference server 102 to participate in a multi-party conference established in the multi-party conference server 102.

The authority controller 204 accepts or rejects the request for sharing content according to whether a host terminal is designated to the multi-party conference and whether the requesting terminal is a presenter terminal.

In the embodiments of the present disclosure, the authority controller 204 is configured to have an individual determination criterion for acceptance or rejection of the request for sharing content according to whether or not a separate host terminal has been designated to the multi-party conference to which the conference participant terminal 104 requesting the sharing of content is connected.

First, when a host terminal is not designated to the multi-party conference, in other words, none of the conference participant terminals 104 connected to the multi-party conference announces holding the right of hosting the multi-party conference, all the conference participant terminals 104, in principle, have the right to freely share content. However, even in this case, it is not possible for two or more participants to simultaneously share content. Accordingly, when the authority controller 204 receives a request for sharing content from a specific conference participant terminal 104, for example, terminal A 104-1, the authority controller 204 registers terminal A 104-1 as a presenter terminal, and when the content sharing of terminal A 104-1 is completed, the authority controller 204 unregisters terminal A 104-1 as the presenter terminal so that other terminals connected to the multi-party conference can share the content. When another terminal (e.g., terminal B 104-1) previously registered as a presenter terminal exists at the time of receiving a request for sharing content from terminal A 104-1, the authority controller 204 rejects the request for sharing content. That is, only when a terminal previously registered as a presenter terminal does not exist at the time of receiving the request for sharing content, the authority controller 204 registers the conference participant terminal 104, which has requested the sharing of content, as a presenter terminal, and accepts the request for sharing content received from the terminal. When a plurality of conference participant terminals 104 issue requests for sharing content at the same time, the authority controller 204 is operable to accept the first received request of the conference participant terminal 104 and reject the requests from the other conference participant terminals 104. By doing so, only one conference participant terminal is allowed to share content at the same time.

Hereinafter, a case in which a host terminal is designated to a multi-party conference will be described. When there are many participants in a multi-party conference, attempts of multiple participants to share content at the same time are likely to frequently occur. In this case, in order to prevent conflicts that may occur, the multi-party conference server 102 may designate a specific host terminal among the participant terminals connected to the conference and select a presenter terminal with which the host terminal shares content. The designation of a host of the multi-party conference may be performed in various ways. For example, a participant terminal that has established an initial multi-party conference may be designated as a host terminal, or a participant terminal that has separately announced holding the right of hosting the multi-party conference may be designated as a host terminal. After the host terminal has been designated, the participant in the multi-party conference is allowed to share content only when designated as the presenter terminal by the host terminal.

Specifically, when the authority controller 204 receives a request for sharing content from a specific conference participant terminal 104, i.e., terminal A 104-1, the authority controller 204 determines whether terminal A 104-1 has been designated as a presenter terminal by the host terminal (e.g., terminal C 104-3). If the determination indicates that terminal A 104-1 has been designated as a presenter terminal, the authority controller 204 accepts the request for sharing content, and otherwise, rejects the request for sharing content.

In one embodiment, the sharing request receiver 202 and the authority controller 204 may be implemented on a computing device including one or more processors and a computer-readable recording medium connected to the one or more processors. The computer-readable recording medium may be present inside or outside of the processors and may be connected to the processors by various well-known means. The processors present inside the computing device may allow each computing device to operate according to exemplary embodiments described herein. For example, the processors may execute an instruction stored in the computer-readable recording medium, and the instruction stored in the computer-readable recording medium may be configured to allow the computing device to execute operations according to the exemplary embodiments described herein when executed by the processors.

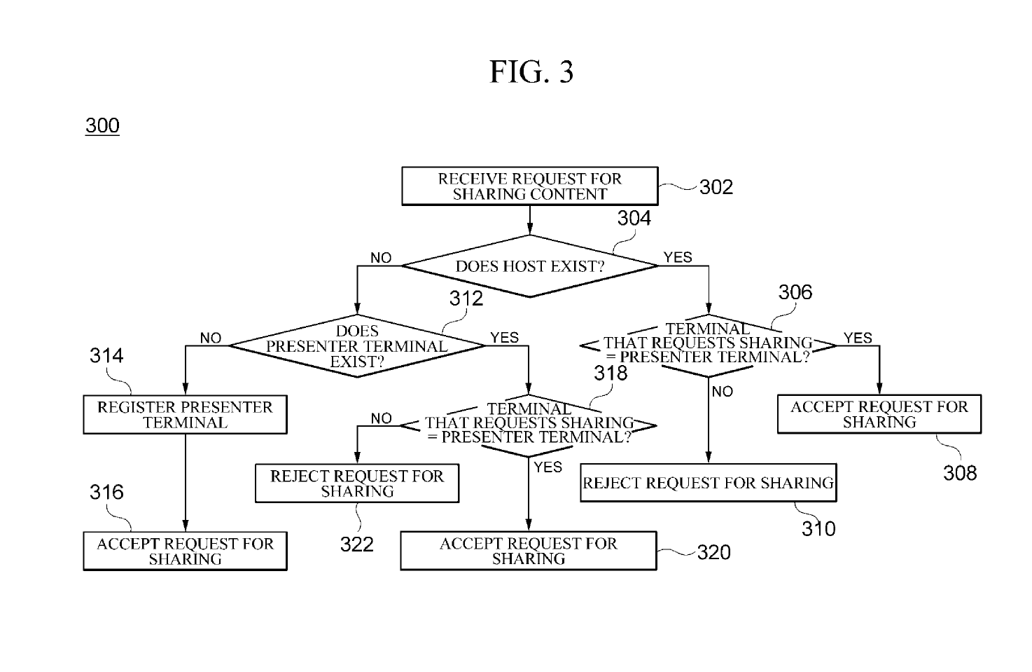

FIG. 3 is a flowchart for describing a right management method 300 according to one embodiment of the present disclosure. The method shown in FIG. 3 may be performed by a computing device including one or more processors and a memory in which one or more programs to be executed by the one or more processors are stored, for example, the above-described multi-party conference server 102. In the flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 302, the sharing request receiver 202 of the multi-party conference server 102 receives a request for sharing content from a terminal 104 that connects to the multi-party conference server 102 and participates in a multi-party conference.

In operation 304, the authority controller 204 of the multi-party conference server 102 determines whether a host terminal has been designated to the multi-party conference.

In operation 306, when it is determined in operation 304 that the host terminal has been designated, the authority controller 204 determines whether the terminal 104 which requests the sharing of content is designated as a presenter terminal by the host terminal.

When it is determined in operation 306 that the terminal 104 requesting the sharing of content is designated as a presenter terminal, the authority controller 204 accepts the request for sharing content in operation 308.

In contrast, when it is determined in operation 306 that the terminal 104 requesting the sharing of content is not designated as a presenter terminal, the authority controller 204 rejects the request for sharing content in operation 310.

Meanwhile, when it is determined in operation 304 that the host terminal has not been designated, the authority controller 204 determines whether a terminal which has been previously registered as a presenter terminal exists at the time of receiving the request for sharing content in operation 312.

When it is determined in operation 312 that a terminal previously registered as a presenter terminal does not exist, the authority controller 204 registers the terminal 104 requesting the sharing of content as the presenter terminal in operation 314.

In operation 316, the authority controller 204 accepts the request of the terminal 104 for sharing content.

Meanwhile, when it is determined in operation 312 that a terminal previously registered as a presenter terminal exists, the authority controller 204 determines whether or not the terminal 104 requesting the sharing of content is the terminal previously registered as a presenter terminal in operation 318.

When it is determined in operation 318 that the terminal 104 requesting the sharing of content is the terminal previously registered as a presenter terminal, the authority controller 204 accepts the request for sharing content in operation 320.

In contrast, when it is determined in operation 318 that the terminal 104 requesting the sharing of content is not the terminal previously registered as a presenter terminal, in other words, when another terminal that has been previously registered as a presenter terminal exists at the time of receiving the request for sharing content, the authority controller 204 rejects the request for sharing content in operation 322.

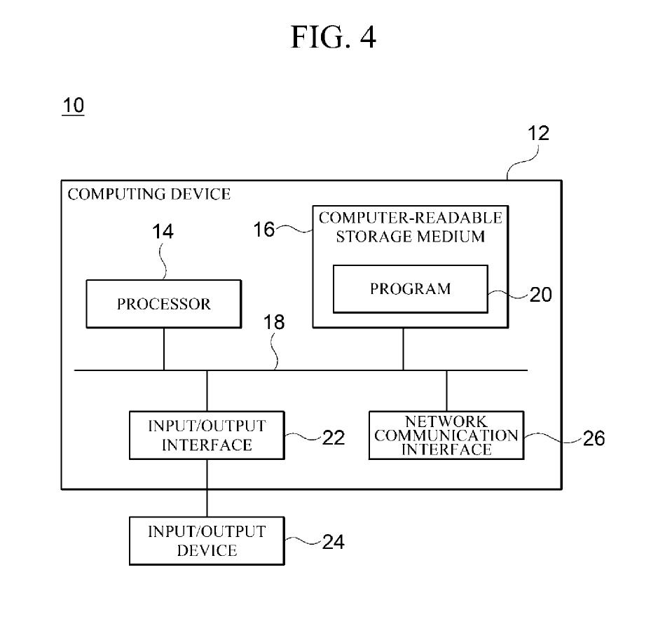

FIG. 4 is a block diagram for describing an example of a computing environment 10 including a computing device suitable to be used in exemplary embodiments. In the illustrated embodiment, each of the components may have functions and capabilities different from those described hereinafter and additional components may be included in addition to the components described herein.

The illustrated computing environment 10 includes a computing device 12. In one embodiment, the computing device 12 may be an audio conference server 102. In addition, the computing device 12 may be a web conference server 104, a host terminal 106 or at least one general conferee terminal 108. The computing device 12 may include at least one processor 14, a computer-readable storage medium 16, and a communication bus 18. The processor 14 may cause the computing device 12 to operate according to the aforementioned exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the illustrative embodiment.

The computer-readable storage medium 16 is configured to store computer executable commands and program codes, program data and/or information in other suitable forms. The programs stored in the computer readable storage medium 16 may include a set of commands executable by the processor 14. In one embodiment, the computer readable storage medium 16 may be a memory (volatile memory, such as random access memory (RAM), non-volatile memory, or a combination thereof) one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24 which is one component constituting the computing device 12 may be included inside the computing device 12 or may be configured as a separate device from the computing device 12 and connected to the computing device 12.

According to the disclosed embodiments, in a multi-party conference in which a participant requests sharing of content, it is possible to accurately determine whether the participant is authorized to share content by taking into consideration whether a host terminal has been designated and whether the requesting terminal is designated as a presenter terminal.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-party conferencing apparatus comprising:
a receiver configured to receive a request for sharing content from a terminal connected to a multi-party conference; and
an authority controller configured to accept or reject the request for sharing content according to whether a host terminal has been designated to the multi-party conference and whether the terminal is a presenter terminal.

2. The multi-party conferencing apparatus of claim 1, wherein the authority controller accepts the request for sharing content when the host terminal has been designated and the terminal is designated as the presenter terminal by the host terminal.

3. The multi-party conferencing apparatus of claim 2, wherein the authority controller rejects the request for sharing content when the terminal is not designated as the presenter terminal by the host terminal.

4. The multi-party conferencing apparatus of claim 1, wherein the authority controller registers the terminal as the presenter terminal and accepts the request for sharing content when the host terminal has not been designated and a terminal previously registered as the presenter terminal does not exist at the time of receiving the request for sharing content.

5. The multi-party conferencing apparatus of claim 4, wherein the authority controller rejects the request for sharing content when another terminal previously registered as the presenter terminal exists at the time of receiving the request for sharing content.

6. The multi-party conferencing apparatus of claim 4, wherein the authority controller accepts the request for sharing content when the terminal is the terminal previously registered as the presenter terminal.

7. A right management method which is performed by a multi-party conference server including one or more processors and a memory in which one or more programs to be executed by the one or more processors are stored, the right management method comprising:
receiving a request for sharing content from a terminal connected to a multi-party conference; and
accepting or rejecting the request for sharing content according to whether a host terminal has been designated to the multi-party conference and whether the terminal is a presenter terminal.

8. The right management method of claim 7, wherein the accepting or rejecting of the request comprises accepting the request for sharing content when the host terminal has been designated and the terminal is designated as the presenter terminal by the host terminal.

9. The right management method of claim 8, wherein the accepting or rejecting of the request comprises rejecting the request for sharing content when the terminal is not designated as the presenter terminal by the host terminal.

10. The right management method of claim 7, wherein the accepting or rejecting of the request comprises, when the host terminal has not been designated and a terminal previously registered as the presenter terminal does not exist at the time of receiving the request for sharing content, registering the terminal as the presenter terminal and accepting the request for sharing content.

11. The right management method of claim 10, wherein the accepting or rejecting of the request comprises rejecting the request for sharing content when another terminal previously registered as the presenter terminal exists at the time of receiving the request for sharing content.

12. The right management method of claim 10, wherein the accepting or rejecting of the request comprises accepting the request for sharing content when the terminal is the terminal previously registered as the presenter terminal.
